(19) United States
(12) Patent Application Publication
(10) Pub. No.: US 2006/0110108 A1
(43) Pub. Date: May 25, 2006

(54) Tunable light transceiver module

(76) Inventors: Tsung-Fu Hsieh, Hsinchu (TW); Chien-Cheng Yang, Hsinchu (TW); Wen-Jiun Liu, Hsinchu (TW); Shau-Yi Chen, Hsinchu (TW); Jing-Yao Chang, Hsinchu (TW)

Correspondence Address: RABIN & BERDO, P.C.;Suite 500, 1101 14 Street, N.W., Washington, DC, 20005, US

(21) Appl. No.: 11/227,609

(22) Filed: Sep. 16, 2005

(30) Foreign Application Priority Data
Nov. 25, 2004 (TW) 93136321

(51) Int. Cl. G02B 6/36

(52) U.S. Cl. 385/92

(57) ABSTRACT

A tunable light transceiver module for adjusting a photoelectric device is provided. The tunable structure includes a photoelectric device, a stage, and a set of two-dimensional actuators having a first direction actuator and a second direction actuator. The photoelectric device is installed on the stage. The first direction actuation device and the second direction actuation device are coupled to the stage for controlling the movement of the stage along the first direction and the second direction, which are parallel to the stage. The tunable module may comprise an additional vertical actuator for controlling the movement of the stage along the direction perpendicular to the stage, thus realizing the displacement adjustment in three dimensions.

### BACKGROUND

1. Field of Invention

The invention relates to a tunable structure, especially to a tunable light transceiver module.

2. Related Art

With the rapid development of Internet communications and in an effort to cope with the future trend of wide band (WB) high speed communication, the demand for the speed and quality of such communication is increasing; and the light transmission related optical fiber products are evidently the mainstay of the present and future communication industry. Therefore, optical fiber products have become increasingly important. The light transceiver module having a light transceiver function and capability is an important active component, which is used to transmit and receive light. However, such a high speed communication system, using the optical fiber as the communication medium must have the support of high quality light transceiver thus meeting the demand of the users.

In the development of the technology of the light transceiver module, the trend of its packaging is towards miniaturization, due to the demand for thin profile, lightness, compact size, and the requirement for the ever increasing speed of communication using the optical fiber. As such, the demand for precise alignment is particular strict, as the result of the requirement for high precision coupling efficiency between the laser light source and the optical fiber.

In general, in the conventional prior art, the active type alignment is done manually. Consequently, it takes a longer time and much more manpower, and thus is disadvantageous to its mass production. On the contrary, the passive type alignment is much more suitable for the automatic production and the reduction of cost. In U.S. Pat. No. 5,499,312 is disclosed an alignment technology, wherein the design of flip chip connection is utilized to achieve the passive alignment of the light wave guide and the photo-electric devices, by making use of a solder, to connect the light wave guide, the substrate, and the photo-electric device through the self alignment as a result of the surface tension of the solder balls. Only through the precisely calculated grain size and solder balls distribution can this kind of alignment achieve its optimized results. However, no matter what kind of alignments utilized, in the existing framework of optical communication system, the problems of post-welding displacement, bending of optical fiber, and gap deviations between enamel sleeves of different optical fibers may develop in the packaging and assembly processes, for example laser welding and optical fiber placement processes, of the active devices of the light transceiver module, thus adversely affecting the coupling quality of the optical signals and significantly attenuating the transmission intensity of the optical signals.

In the micro electromechanical system (MEMS), the actuation device is used usually in a two-dimensional movement. Presently, this kind of technology is developed and utilized in controlling the read/write head of the recording device or the probe of the scanning probe microscope. As disclosed in the published patent application case US patent publication No. 20020047493, wherein an electrostatic comb-drive actuator is used to control the micro-stage thus, to design and develop the movable device that can be moved in the two dimensional X- and Y-axes.

In addition, as disclosed in the published patent application case US patent publication No. 20020136485, a two-dimensional comb-drive displacement device is provided, wherein the micro-stage is incorporated into the two sets of comb-drive actuators for being controlled in each of the two directions. The two sets of actuators are coupled to the micro-stage separately through two sets of springs. When one set of comb-drive actuators moves in one direction, the other set of comb-drive actuators is capable of maintaining the original position through the absorption of the displacement by the springs. At present, this technology has not yet been applied to the adjustment of the light transceiver module, besides, the movement of the micro-stage is restricted to the planar direction only.

### SUMMARY OF THE INVENTION

In view of the above-mentioned problems and shortcomings of the prior art, the object of the invention is to provide a light transceiver module installed in a movable stage, so as to modify the alignment deviations real time as caused by the packaging process. The invention provides an tunable light transceiver module, which is capable of controlling the positions of the packaged light transceiver module by means of the actuation device moving in vertical direction, in cooperation with the actuation device moving in the other two dimensions, so that the light transceiver module is still capable of meeting the requirement of real time coupling, fast action, refined micro adjustments after welding and packaging, thus is able to modify, real time, the adjustment deviations caused by the post-welding displacement, gap deviation, and optical fiber bending between the light transceiver module and the optical fiber.

The tunable light transceiver module disclosed in the invention is used to adjust the position of the photo-electric device, comprising: a photo-electric device, a stage and a set of planar actuation devices. The planar actuation devices includes: a first direction actuation device and a second direction actuation device, wherein the photo-electric device is installed at the stage, the first direction actuation device and the second direction actuation device are coupled respectively to the stage for adjusting the movement of the stage, the first direction actuation device is used to control the movement parallel to the first direction of the stage, and the second direction actuation device is used to control the movement parallel to the second direction of the stage, thus to control the planar position of the photo-electric device to align with the optical fiber. Additionally, light flux can be adjusted through adjusting the movement of the photo-electric device, and as such the power transmitted from the photo-electric device to the optical fiber can also be adjusted.

Another type of tunable light transceiver module is further disclosed in the invention, which is used to adjust the movement in three dimensions, comprising: a photo-electric device, a stage and a set of a planar actuation devices and a vertical actuation device. The planar actuation devices include: a first direction actuator and a second direction actuator, wherein the photo-electric device is installed on the stage, the first direction actuation device, the second direction actuation device, and the vertical actuation device are coupled respectively to the stage for adjusting the movement of the stage. The first direction actuation device is used to control the movement parallel to the first direction of the stage, the second direction actuation device is used to control the movement parallel to the second direction of the stage, and the vertical actuation device is used to control the movement parallel to the vertical direction of the stage. Through the three dimensional adjustment of the movement of the photoelectric device, the power transmission from the photoelectric device to the optical fiber can be modulated more precisely.

The photoelectric devices utilized in the invention include: a light emitting device, a lens and a photo sensor, wherein the micro-actuator used can be one of the following actuators: the electrostatic actuator, the electrostatic comb-drive actuator, the thermal array actuators, and the magnetic actuators. The major construction of the invention is composed of the stage and the actuators, which may be mass-produced in conjunction with the existing micro electric-mechanical system technology and the equipment, to save the production cost.

The invention is realized by making use of the existing technology, and the various devices are imparted with new functions and applications, as such the invention can easily be incorporated into the existing domain of light wave communication.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, wherein:

FIG. 1 is a schematic diagram illustrating the tunable light transceiver module according to the embodiment of the invention; and

FIG. 2 is a schematic diagram of a tunable light transceiver module with an additional Z-axis actuation device according to the embodiment of the invention.

### DETAILED DESCRIPTION

In the tunable light transceiver module, the three dimensional movement of the stage is controlled by the actuation devices, so that the relative position of the photoelectric device of the packaged light transceiver module can be precisely adjusted. In the embodiment of the invention, the electrostatic comb-drive micro-actuator is realized as the actuation device. The essence of its driving principle lies in providing an appropriate level of voltage to the two comb-shaped electrode plates spaced a distance apart, so that an electrostatic force is generated between the two electrode plates, thus resulting in the mutual attraction of the two electrode plates.

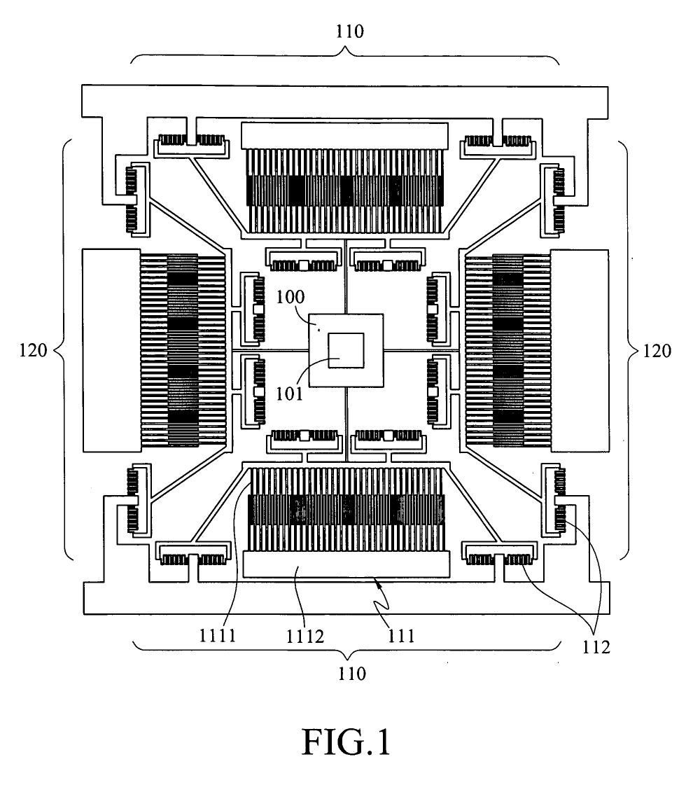

Refer to FIG. 1, which shows the schematic diagram of the tunable light transceiver module according to the embodiment of the invention. As shown in FIG. 1, the X-axis and Y-axis represent the first direction and second direction of the planar actuation device, which is used to adjust the position of the photo-electric device 101 relative to that of the light transceiver module. The tunable mechanism includes: a stage 100, an X-axis actuation device 120 and a Y-axis actuation device 110. Wherein the photoelectric device 101 is installed on stage 100, the X-axis actuation device 120 and Y-axis actuation device 110 are coupled respectively to stage 100, for adjusting the movement of stage 100. The X-axis actuation device 120 and Y-axis actuation device 110 include two electrostatic comb-drive actuators 111 respectively. The two electrostatic comb-drive actuators 111 of the X-axis actuation device 120 are disposed at two horizontal sides of a stage 100 for controlling the movement parallel to the horizontal direction of the stage 100. The two electrostatic comb-drive actuators 111 of the Y-axis actuation device 110 are disposed at the two vertical sides of stage 100, for controlling the movement parallel to the vertical direction of the stage 100.

Each of the electrostatic comb-drive actuators 111 includes a movable comb electrode plate 1111 and a fixed comb electrode plate 1112. The movable comb electrode plate 1111 is connected to stage 100. The movable comb electrode plate 1111 and the fixed comb electrode plate 1112 are spaced a distance apart, and are mutually interleaved with their respective comb teeth. When voltage is applied on the two electrode plates, a mutually attractive electrostatic force is generated between the movable comb electrode plate 1111 and the fixed comb electrode plate 1112, which is used to drive the movable comb electrode plate 1111, thus resulting in the movement of the stage 100. In the embodiment of the invention, there is further provided a plurality of springs to serve as an elastic element 112, which are fixed at the light transceiver module and are connected to the movable comb electrode plate 1111. The movement of the movable comb electrode plate 1111 can thus be buffered by the deformation of the elastic element 112, which is fixed to the light transceiver module. In addition, the plurality of elastic elements is connected to the movable comb electrode plate 1111 to support the suspension of the stage 100, to buffer the movement of the movable comb electrode plate 1111.

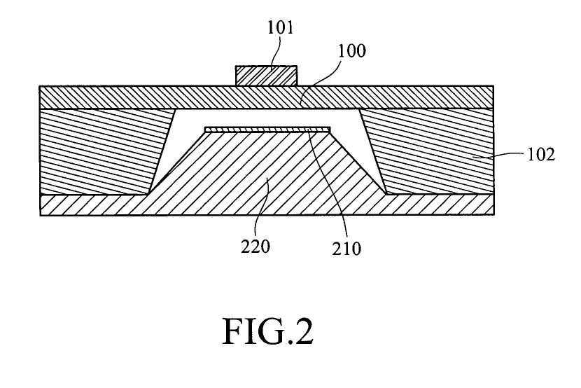

The invention may also include a Z-axis actuation device as a vertical actuation device, to conduct the displacement adjustment in 3 dimensions. Refer to FIG. 2, which shows the schematic diagram of an tunable light transceiver module with an additional Z-axis actuation device according to the embodiment of the invention, in which the photo-electric device 101 is installed on the stage 100, the Z-axis actuation device is coupled to the lower portion of the stage 100, to adjust the vertical direction movement perpendicular to the stage 100. The Z-axis actuation device is an electrostatic actuator. An upper electrode (not shown) is arranged on the stage, and a lower electrode 210 is arranged a certain distance therefrom on the base 220 below the stage 100. When voltage is applied on the upper electrode and the lower electrode 210, then the stage, 100 having the upper electrode, will move in vertical direction. As such, the movement of the photoelectric device 101 can be adjusted in three dimensions, so that the power transmission between the photoelectric device and the optical fiber can be precisely controlled and modulated.

In addition, the tunable light transceiver module of the invention further includes a locking device, which is used to lock the stage after the adjustment, so that there is no need to continue applying voltage to maintain the electrostatic force to keep the stage in place.

Through the application and implementation of the invention, the coupling error and the attenuation of light intensity due to the post-welding displacement, gap deviation and alignment error can be corrected real time, furthermore, better light flux modulation can be achieved through more precise displacement adjustment according to the various actual requirements.

Knowing the invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An tunable light transceiver module, comprising:
a stage;
a photoelectric device, installed on said stage; and
a set of planar actuation device, coupled to said stage for adjusting the planar movement of said stage, comprising:
a first direction actuation device, used to control a first direction movement paralleling said stage; and
a second direction actuation device, used to control a second direction movement paralleling said stage.

2. The tunable light transceiver module of claim 1, wherein said photoelectric device is selected from the group consisting of a light emitting device, a lens, and a photo sensor.

3. The tunable light transceiver module of claim 1, wherein said first direction actuation device is used to control the displacement paralleling the horizontal direction of the stage.

4. The tunable light transceiver module of claim 1, wherein said second direction actuation device is used to control the displacement paralleling the vertical direction of the stage.

5. The tunable light transceiver module of claim 1, wherein said first direction actuation device is selected from the group consisting of an electrostatic actuator, an electrostatic comb-drive actuator, a thermal array actuator, and a magnetic actuator.

6. The tunable light transceiver module of claim 5, wherein said first direction actuator includes at least one electrostatic comb-drive actuator, which includes a movable comb electrode plate and a fixed comb-drive electrode plate, said movable comb electrode plate is connected to said stage, and is spaced a distance from said fixed comb electrode plate, and the comb teeth of said movable comb electrode plate and said fixed comb-drive electrode plate interleave each other, and when voltage is applied on said two electrode plates, a mutually attractive electrostatic force is generated between said two electrode plates, which is used to drive said movable comb electrode plate, thus bringing about the displacement of said stage in the first direction.

7. The tunable light transceiver module of claim 6, further comprising a plurality of elastic elements fixed to the light transceiver module and connected to the movable comb electrode plate.

8. The tunable light transceiver module of claim 1, wherein said second direction actuation device is selected from the group consisting of an electrostatic actuator, an electrostatic comb-drive actuator, a thermal array actuator, and a magnetic actuator.

9. The tunable light transceiver module of claim 8, wherein said second direction actuator includes at least one electrostatic comb-drive actuator, which includes a movable comb-drive electrode plate and a fixed comb-drive electrode plate, said movable comb-drive electrode plate is connected to said stage, and is spaced a distance from said fixed comb-drive electrode plate, and the comb teeth of said movable comb-drive electrode plate and said fixed comb-drive electrode plate interleave each other, and when voltage is applied on said two electrode plates, a mutually attractive electrostatic force is generated between said movable comb-drive electrode plate and said fixed comb-drive electrode plate, which is used to drive said movable comb-drive electrode plate, thus bringing about the displacement of said stage in the second direction.

10. The tunable light transceiver module of claim 9, further comprising a plurality of elastic elements fixed to the light transceiver module and connected to the movable comb electrode plate.

11. The tunable light transceiver module of claim 1, further comprising a vertical actuator used to control the vertical direction displacement perpendicular to said stage.

12. The tunable light transceiver module of claim 11, wherein the vertical actuation device is selected from the group consisting of an electrostatic actuator and a magnetic actuator.

13. The tunable light transceiver module of claim 11, wherein said vertical actuator is an electrostatic actuator, comprising an upper electrode and a lower electrode, when voltage is applied on said upper electrode and said lower electrode, a mutually attractive electrostatic force is generated between said two plates thus to bring about the vertical direction movement of said stage having said upper electrode.

14. The tunable light transceiver module of claim 1, further comprising a locking mechanism used to fix said stage after the position adjustment.
